(19) United States
(12) Patent Application Publication
(10) Pub. No.: US 2020/0076718 A1
(43) Pub. Date: Mar. 5, 2020

(54) HIGH BANDWIDTH USING MULTIPLE PHYSICAL PORTS

(71) Applicant: NOKIA SOLUTIONS AND NETWORKS OY, Espoo (FI)

(72) Inventors: Yusuf KHAN, Neu-Ulm (DE); Ravi Prasad RK, Bangalore (IN); Siby MATHEW, Bangalore (IN)

(21) Appl. No.: 16/119,370

(22) Filed: Aug. 31, 2018

(51) Int. Cl. H04L 12/26; H04L 12/851; H04L 29/06

(52) U.S. Cl. CPC H04L 43/0852; H04L 63/0485; H04L 63/08; H04L 47/24

(57) ABSTRACT

A method of transmitting a data flow over a link aggregation group (LAG), including: comparing the bandwidth demand of the data flow with the capacity of a first link assigned to the flow in the LAG; identifying an underutilized second link in the LAG when the bandwidth demand of the flow is greater than the capacity of the link assigned to the flow resulting in excess packets; determining if the second link is available; determining the traffic type of the traffic flow; calculating a time delay and delaying excess packets of the traffic flow by the calculated time delay when the determined traffic type does not include a packet sequence number; and sending excess packets of the traffic flow on the second link.

### TECHNICAL FIELD

Various exemplary embodiments disclosed herein relate generally to high bandwidth using multiple physical ports.

### BACKGROUND

One of the key requirements of mobile backhaul emerging from 5G is achieving high capacity and bit rate for a single user, with data rates up to 20 Gbps per user arising from 5G use cases such as Full HD video streaming from mobile phones, action cameras, drones, 4K UHD video streaming, 8K UHD video streaming, augmented reality and virtual reality. Network nodes today provide the traditional backhaul which has hardware network interface cards (NIC) capable of fulfilling bandwidth requirements of existing mobile backhaul for WCDMA and LTE.

### SUMMARY

A summary of various exemplary embodiments is presented below. Some simplifications and omissions may be made in the following summary, which is intended to highlight and introduce some aspects of the various exemplary embodiments, but not to limit the scope of the invention. Detailed descriptions of an exemplary embodiment adequate to allow those of ordinary skill in the art to make and use the inventive concepts will follow in later sections.

Various embodiments relate to a method of transmitting a data flow over a link aggregation group (LAG), including: comparing the bandwidth demand of the data flow with the capacity of a first link assigned to the flow in the LAG; identifying an underutilized second link in the LAG when the bandwidth demand of the flow is greater than the capacity of the link assigned to the flow resulting in excess packets; determining if the second link is available; determining the traffic type of the traffic flow; calculating a time delay and delaying excess packets of the traffic flow by the calculated time delay when the determined traffic type does not include a packet sequence number; and sending excess packets of the traffic flow on the second link.

Various embodiments are described, further including sending the excess packets of the traffic flow on the first link when the second link is not available.

Various embodiments are described, wherein the time delay is calculated based upon a first link speed, a second link speed, a first link packet length, and a second link packet length.

Various embodiments are described, wherein the time delay is also calculated based upon a randomly generated time delay.

Various embodiments are described, wherein sending excess packets of the traffic flow on the second link further includes moving a transmit affinity of the flow from the first link to the second link.

Various embodiments are described, wherein further including: determining that the bandwidth demand of the flow is less than the capacity of a first link after sending excess packets of the traffic flow on the second link; and moving a transmit affinity of the flow from the second link to the first link.

Further various embodiments relate to a method of processing data flows over a plurality of links in a link aggregation group (LAG) at a network node, including: receiving data packets in a first flow from a first link; receiving data packets in the first flow from a second link; determining the traffic type of the first flow from the first link; determining the traffic type of the first flow from the second link; recovering the order of data packets in the first flow when the determined traffic type of the first flow includes a packet sequence number; and sending the reordered data packets to a LAG logical device.

Various embodiments are described, further including sending the data packets from the first link and the second link to the LAG logical device when the determined traffic type does not include a packet sequence number.

Various embodiments are described, wherein further including: comparing the bandwidth demand of a second transmitted flow with the capacity of a third link assigned to the second flow in the LAG; identifying an underutilized fourth link in the LAG when the bandwidth demand of the second flow is greater than the capacity of the third link assigned to the flow resulting in excess packets; determining if the fourth link is available; determining the traffic type of the second traffic flow; calculating a time delay and delaying excess packets of the second traffic flow by the calculated time delay when the determined traffic type does not include a packet sequence number; and sending excess packets of the second traffic flow on the fourth link.

Various embodiments are described, wherein the sequence number is part of an internet protocol security (IPsec) protocol authentication header (AH).

Various embodiments are described, wherein the packet sequence number is part of an encapsulating security payload (ESP) header.

Further various embodiments relate to a network node for transmitting a data flow over a link aggregation group (LAG), including: a processor; a memory including computer code, wherein the memory and the computer code configured to, with the processor, cause the network node to at least perform: comparing the bandwidth demand of the data flow with the capacity of a first link assigned to the flow in the LAG; identifying an underutilized second link in the LAG when the bandwidth demand of the flow is greater than the capacity of the link assigned to the flow resulting in excess packets; determining if the second link is available; determining the traffic type of the traffic flow; calculating a time delay and delaying excess packets of the traffic flow by the calculated time delay when the determined traffic type does not include a packet sequence number; and sending excess packets of the traffic flow on the second link.

Various embodiments are described, wherein the memory and the computer code configured to, with the processor, cause the network node to further perform sending the excess packets of the traffic flow on the first link when the second link is not available.

Various embodiments are described, wherein the time delay is calculated based upon a first link speed, a second link speed, a first link packet length, and a second link packet length.

Various embodiments are described, wherein the time delay is also calculated based upon a randomly generated time delay.

Various embodiments are described, wherein sending excess packets of the traffic flow on the second link further includes moving a transmit affinity of the flow from the first link to the second link.

Various embodiments are described, wherein the memory and the computer code configured to, with the processor, cause the network node to further perform: determining that the bandwidth demand of the flow is less than the capacity of a first link after sending excess packets of the traffic flow on the second link; and moving a transmit affinity of the flow from the second link to the first link.

Further various embodiments relate to a network node for processing data flows over a plurality of links in a link aggregation group (LAG), including: a processor; a memory including computer code, wherein the memory and the computer code configured to, with the processor, cause the network node to at least perform: receiving data packets in a first flow from a first link; receiving data packets in the first flow from a second link; determining the traffic type of the first flow from the first link; determining the traffic type of the first flow from the second link; recovering the order of data packets in the first flow when the determined traffic type of the first flow includes a packet sequence number; and sending the reordered data packets to a LAG logical device.

Various embodiments are described, wherein the memory and the computer code configured to, with the processor, cause the network node to further perform sending the data packets from the first link and the second link to the LAG logical device when the determined traffic type does not include a packet sequence number.

Various embodiments are described, wherein the memory and the computer code configured to, with the processor, cause the network node to further perform:

comparing the bandwidth demand of a second transmitted flow with the capacity of a third link assigned to the second flow in the LAG; identifying an underutilized fourth link in the LAG when the bandwidth demand of the second flow is greater than the capacity of the third link assigned to the flow resulting in excess packets; determining if the fourth link is available;

determining the traffic type of the second traffic flow; calculating a time delay and delaying excess packets of the second traffic flow by the calculated time delay when the determined traffic type does not include a packet sequence number; and sending excess packets of the second traffic flow on the fourth link.

Various embodiments are described, wherein the sequence number is part of an internet protocol security (IPsec) protocol authentication header (AH).

Various embodiments are described, wherein the packet sequence number is part of an encapsulating security payload (ESP) header.

Further various embodiments relate to a network node for transmitting a data flow over a link aggregation group (LAG), including: means for comparing the bandwidth demand of the data flow with the capacity of a first link assigned to the flow in the LAG; means for identifying an underutilized second link in the LAG when the bandwidth demand of the flow is greater than the capacity of the link assigned to the flow resulting in excess packets; means for determining if the second link is available; means for determining the traffic type of the traffic flow; means for calculating a time delay and delaying excess packets of the traffic flow by the calculated time delay when the determined traffic type does not include a packet sequence number; and means for sending excess packets of the traffic flow on the second link.

Various embodiments are described, further including means for sending the excess packets of the traffic flow on the first link when the second link is not available.

Various embodiments are described, wherein the time delay is calculated based upon a first link speed, a second link speed, a first link packet length, and a second link packet length.

Various embodiments are described, wherein the time delay is also calculated based upon a randomly generated time delay.

Various embodiments are described, wherein means for sending excess packets of the traffic flow on the second link further includes means for moving a transmit affinity of the flow from the first link to the second link.

Various embodiments are described, further including: means for determining that the bandwidth demand of the flow is less than the capacity of a first link after sending excess packets of the traffic flow on the second link; and moving a transmit affinity of the flow from the second link to the first link.

Further various embodiments relate to a network node for processing data flows over a plurality of links in a link aggregation group (LAG) at a network node, including: means for receiving data packets in a first flow from a first link; means for receiving data packets in the first flow from a second link; means for determining the traffic type of the first flow from the first link; means for determining the traffic type of the first flow from the second link; means for recovering the order of data packets in the first flow when the determined traffic type of the first flow includes a packet sequence number; and means for sending the reordered data packets to a LAG logical device.

Various embodiments are described, further including means for sending the data packets from the first link and the second link to the LAG logical device when the determined traffic type does not include a packet sequence number.

Various embodiments are described, further including: means for comparing the bandwidth demand of a second transmitted flow with the capacity of a third link assigned to the second flow in the LAG; means for identifying an underutilized fourth link in the LAG when the bandwidth demand of the second flow is greater than the capacity of the third link assigned to the flow resulting in excess packets; means for determining if the fourth link is available; means for determining the traffic type of the second traffic flow; means for calculating a time delay and delaying excess packets of the second traffic flow by the calculated time delay when the determined traffic type does not include a packet sequence number; and means for sending excess packets of the second traffic flow on the fourth link.

Various embodiments are described, wherein the sequence number is part of an internet protocol security (IPsec) protocol authentication header (AH).

Various embodiments are described, wherein the packet sequence number is part of an encapsulating security payload (ESP) header.

### BRIEF DESCRIPTION OF THE DRAWINGS

In order to better understand various exemplary embodiments, reference is made to the accompanying drawings, wherein:

FIG. 1 illustrates a LAG deployment between an evolved node B (eNodeB) and a switch;

FIG. 2 illustrates an example of a software defined network (SDN);

FIG. 3 illustrates the packet flows at ports P1 and P2 when flow F1 is not distributed across ports P1 and P2;

FIG. 4 illustrates the packet flow distributed across ports with addition of a time delay when switching a flow from one port to another;

FIG. 5 illustrates a flow diagram of a method incorporating the first and second embodiments for controlling the distribution of a flow in a LAG to multiple ports;

FIG. 6 illustrates a flow diagram of a method incorporating the first and second embodiments for receiving packets from a link aggregation group (LAG); and

FIG. 7 illustrates an exemplary hardware diagram 700 for implementing the LAG at the SDN controller, BTS, eNodeB, switches, SGW, or PGW.

To facilitate understanding, identical reference numerals have been used to designate elements having substantially the same or similar structure and/or substantially the same or similar function.

### DETAILED DESCRIPTION

The description and drawings illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or (i e, and/or), unless otherwise indicated (e.g., “or else” or “or in the alternative”). Also, the various embodiments described herein are not necessarily mutually exclusive, as some embodiments can be combined with one or more other embodiments to form new embodiments.

In 5G networks, data capacity requirements is almost 10-fold the capacity of existing networks, and this data capacity is difficult to achieve with existing mobile backhaul networks. One approach to increase the capacity in existing networks would be link aggregation as most of the edge and core networking hardware have multiple 1Gigabit and 10 Gigabit NIC's which may be aggregated to increase the layer-2 bandwidth.

Software defined networks (SDN) is an approach to networking that allows network administrators to programmatically initialize, control, change, and manage network behavior dynamically via open interfaces and abstraction of lower-level functionality. SDN can cater to 5G high capacity mobile backhaul requirements by dynamically controlling the network nodes to enable or disable link aggregation at the flow level, depending upon allowed/configured and required bandwidth of the flow.

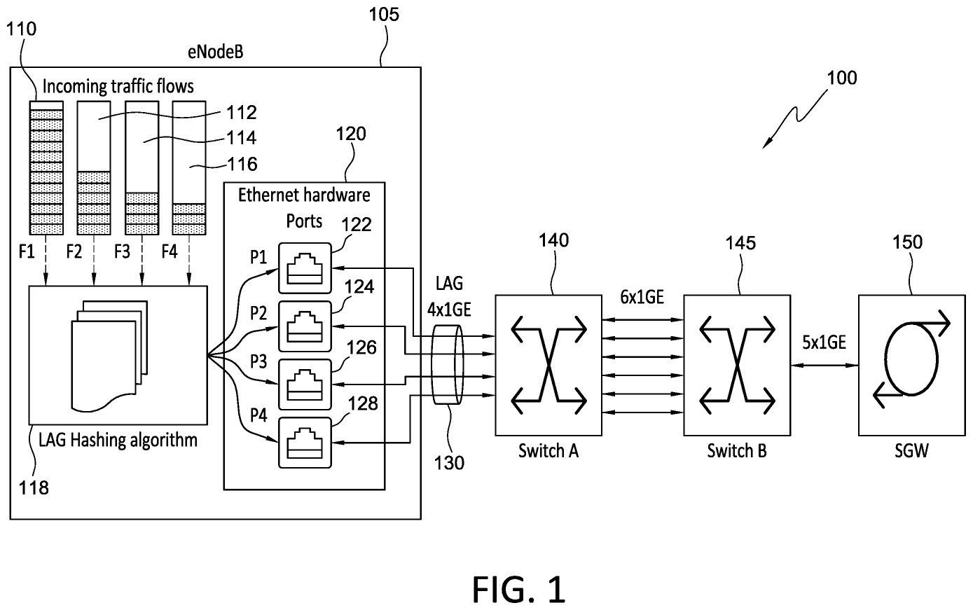

FIG. 1 illustrates a LAG deployment between an eNodeB and a switch. The LAG may be implemented on other types of nodes as well. Link aggregation involves specifying a link number as a physical device and then associating a set of interfaces (i.e., ports) with the link. Also, all links should be configured to operate at the same speed and be in full-duplex mode. LAG should be enabled on both sides of the link. An eNodeB 105 may include Ethernet hardware 120 including ports 122, 124, 126, and 128. The eNodeB 105 may implement a LAG by combining four physical ports (122, 124, 126 and 128) into logical LAG port and transmitting four incoming traffic flows 110, 112, 114, and 116 over the logical LAG port. A LAG hashing algorithm 118 determines how traffic entering a LAG 130 is distributed to different member links associated with ports 122, 124, 126, and 128. The LAG hashing algorithm 118 distributes the incoming traffic flows 110, 112, 114, and 116 evenly across the member links in the LAG 130. The LAG 130 creates a single point-to-point connection. The LAG may be connected to a switch 140 which may be connected to a second switch 145 and switching gateway (SGW) 150.

In current LAG implementations, incoming traffic flow sessions are tied to a LAG member link to avoid a packet reordering problem. If a traffic flow session is distributed across different member links of a LAG there is a risk of out-of-order packets, which causes serious problems for a lot of applications and also results in overall performance degradation due to increased packet retransmissions.

Also, IEEE 802.1AX-2014, an IEEE Standard for Local and metropolitan area networks—Link Aggregation does not specify any method to address the packet re-ordering issue due to the distribution of single flow across multiple links. The IEEE limitation of binding a flow to a specific port is constraint for network nodes like base transceiver station (BTS), evolved node B (eNodeB), or next generation Node B (gNB). Most of the existing LTE hardware have multiple 1Gigabit ports and UE data is normally tunneled in a single tunnel. For example, the tunnel protocol may be general packet radio service tunneling protocol (GIP) or internet protocol security (IPsec) to tunnel data packets towards a serving gateway or a security gateway. With advanced LTE or even with LTE it is possible that total throughput required on the transport side can go well beyond 1 Gigabit.

To further improve the overall LAG performance, embodiments of an efficient method to address out-of-order packet issues when traffic is routed to multiple LAG member links will be described herein. Two different embodiments using two different approaches for splitting a single flow across multiple physical link without re-ordering the packets are as follows.

In the first approach, packets from the same flow may be sent over multiple physical links by introducing a delay when the flow transmit affinity is moved from one physical port to another. Initially the sequence of packets from a traffic flow are sent from same physical link until a maximum configured bandwidth for flow is reached before a scheduler moves the flow transmit affinity to a different physical port, and a LAG scheduler introduces a delay, so that packets are sent and received in order in the time domain.

In a second approach, LAG devices may use internet protocol security (IPsec) protocol (RFC 4302) authentication header (AH) member field to distribute a single flow across multiple physical links without causing a re-ordering issue. The LAG device on the receiving side may then restore the order of the packets at the logical device using sequence number field in the IPsec AH header. Further, the encapsulating security payload (ESP) header (rfc2406) also contains the sequence number. Therefore, LAG devices may also use IPsec ESP tunnel or transport mode to distribute a single flow over multiple physical links. The ESP header encrypts the packet to provide confidentiality, but the ESP may decrease the performance. If the flow is already ESP protected, then this approach may be used without any decrease in performance. Further, this approach may be expanded to any transmission protocol that uses a sequence number for the packet that may be used to reorder the packets upon receipt.

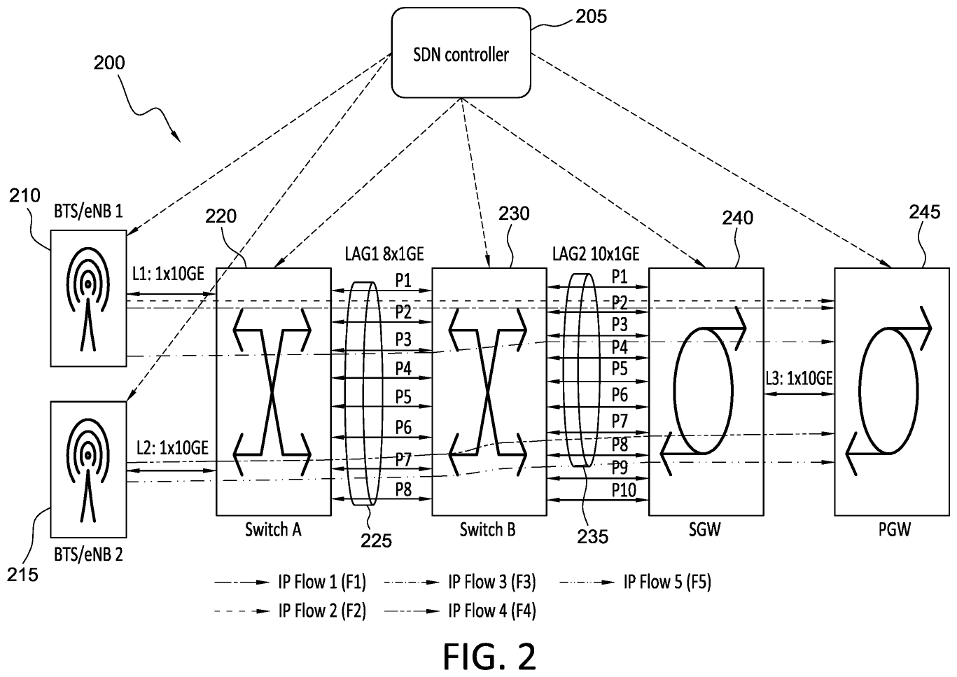

FIG. 2 illustrates an example of a SDN. The SDN 200 may include an SDN controller 205, BTS/eNBs 210 and 215, switches 220 and 230, LAGs 225 and 235, an SGW 240, and a packet data network gateway (PGW) 245. The various elements of the SDN 100 may be controlled by the SDN controller 205 to provide various networking solutions and applications. The SDN may be used to monitor a per flow bandwidth, and if the flow bitrate exceeds a physical port capacity, the SDN controller 205 may dynamically enable LAG for selected network nodes. The problem arises when a single flow has a bit rate that is more than a single physical NIC bandwidth. This situation requires splitting the single flow across multiple physical links without causing re-ordering issue.

FIG. 2 illustrates typical traffic flows F1, F2, F3, F4, and F5 inside LAGs 225 and 235. The LAGs 225 and 235 distributes traffic flows to ports participating in the group based on the hash algorithm as described above. Individual flows have the port affinity set based on the hash algorithm. The port affinity implies here that flow is only transmitted on the specific port. For example, as shown in FIG. 2, flows F1 and F2 are routed on port P1 of switches 220 and 230, flow F3 is routed on port P3, flow F4 is routed on port P7, and flow F5 is routed on port P8.

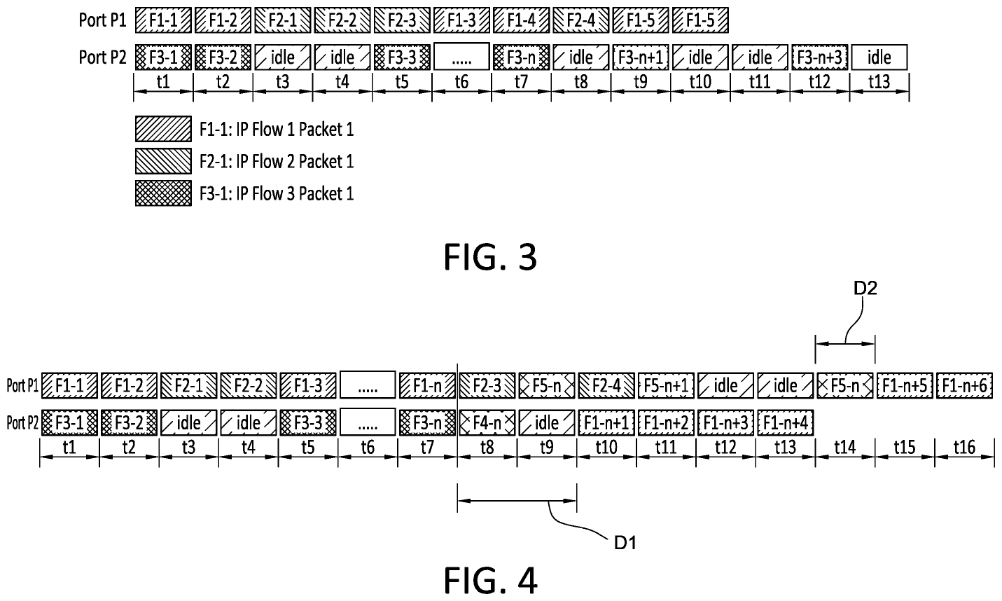

If the traffic on flow F1 increases suddenly beyond the capacity of link P1, transmitting the flow F1 on multiple ports other than port P1 may cause the data packet re-ordering issue described above. FIG. 3 illustrates the packet flows at ports P1 and P2 when flow F1 is not distributed across ports P1 and P2. In FIG. 3, the LAG scheduler schedules flows based on the hash algorithm to a specific port in a LAG. Specifically, flows F1 and F2 are assigned to port P1 and flow F3 is assigned to port P2. The flows at each port are shown as a sequence of packets that are labeled by flow and packet number, e.g., F1-1 is the first packet of flow F1 and F3-3 is the third packet of flow F3. Once the flows are bound to a particular port, then the packets of that flow are sent out only through the bonded port. For example, certain flows such as F1 may have high bit-rate and may not fit within the bandwidth of port P1. On the other hand, certain flows, for example F3, may have very minimal bit-rate resulting in idle times on port P2. As a result, bandwidth of port P2 may remain underutilized causing in-efficient use of available bandwidth for aggregated ports. An example is show in FIG. 3, where flow F1 and F2 is on port P1 and flow F3 is on port P2.

A first embodiment of addressing the out-of-order packet problem when splitting a flow across multiple ports includes using a time delay. In the first embodiment, packets from the same flow may be sent over multiple physical links by introducing a time delay when the flow transmit affinity is moved from one physical port to another. Initially the sequence of packets from a traffic flow are sent on the same physical link until the maximum configured bandwidth for the flow is reached. Before the LAG scheduler moves the flow transmit affinity of the high bandwidth flow to a different physical port, the LAG scheduler introduces a time delay, so that packets are sent and received in order over the time domain. The time delay value will be computed based on physical link properties (like speed, delay due to cable length, etc.) so that packets sent on different sender ports are received in the same order at receiver ports.

FIG. 4 illustrates the addition of a time delay when switching a flow from one port to another. The SDN controller may schedule flow F1 and F2 on port P1, flow F3 and F4 on port P2. When the bitrate of flow F1 increases beyond the physical bandwidth of port P1, the LAG scheduler switches the transmit of flow F1 to underutilized port P2 by inserting a slight time delay before the port switch. As shown in FIG. 4, the inserted time delay D1 is at t8 and t9 when the flow F1 is switched from port P1 to port P2. The length of the time-delay depends on, for example, the port link speed. The time-delay ensures that the packets are sent in order in the time domain so that they are received in order as well. At time t13, the LAG scheduler determines that flow F1 may now be transmitted again on port P1. The LAG scheduler calculates a time delay D2 at t14, and delays transmitting the flow F1 again on port P1. Each time, the LAG scheduler switches the port over which a flow is transmitted, the LAG scheduler inserts a slight time delay before the switch. Thus, the LAG continues to transmit the packets across multiple ports without the reordering problem. The LAG scheduler does not switch the port for flow transmit until the bandwidth of physical port is exhausted, thus making sure that port switch only happens when current port cannot serve the current required bit-rate.

The time delay may be calculated as follows:

Time delay=f(P1LS,P2LS,P1PL,P2PL,random delay),

where, f is a function, P1LS is the current port link speed, P2LS is the next port link speed, P1PL is the packet length of last packet on current port, P2PL is the packet length of first packet on next port, and an optional random delay. In some embodiments the computation of time delay and implementation of the LAG scheduler may be done locally by the switch or by the SDN controller which then communicates the time delay value to the switch.

A second embodiment of addressing the out-of-order packet problem when splitting a flow across multiple ports includes using ESP or AH headers. In this embodiment, LAG devices may use the IPsec AH protocol to distribute a single flow across multiple physical links without causing a re-ordering issue. The LAG device on the receiving side may easily restore the order of the packets at the logical device using the sequence number field in the AH header. As the ESP header also contains a sequence number, LAG devices may also use IPsec ESP tunnel or transport mode to distribute a single flow over multiple physical links. Further, this approach may be expanded to any transmission protocol that uses a sequence number for the packet that may be used to reorder the packets upon receipt.

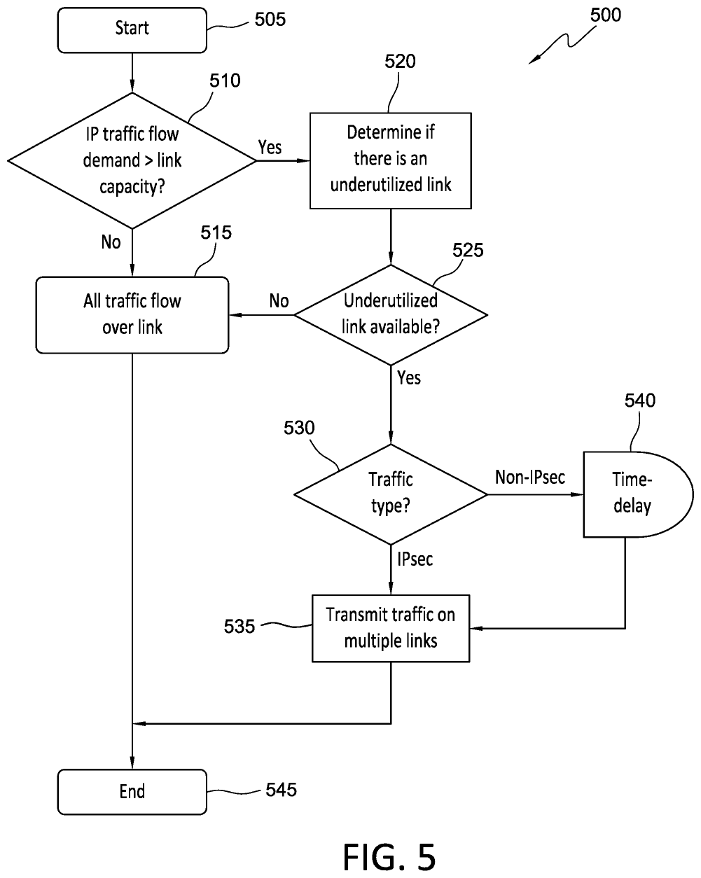

FIG. 5 illustrates a flow diagram of a method incorporating the first and second embodiments for controlling the distribution of a flow in a LAG to multiple ports. SDN controller or any application may configure the time-delay parameter. The method 500 begins at 505. The method 500 then periodically checks the flow bandwidth as compared to the link capacity 510. If the bit-rate is less than the link capacity, then the method proceeds to send all of the traffic flow over the link 515 and the proceeds to end at 545. If the bit-rate increases beyond the port bandwidth, the method 500 determines if there is an underutilized link in the LAG 520. Next the method 500 determines if the underutilized link is available at step 525. If the underutilized link is not available, the method continues to 515 and sends all of the traffic flow over the assigned link. If the underutilized link is available, the method 500 then determines the traffic type 530. If the traffic is IPsec traffic, i.e., if the traffic includes ESP or AH packets, the method 500 proceeds to transmit the traffic flow on multiple links 535 using additional ports without further modification, and then the method proceeds to end at 545. If the traffic is not IPsec traffic, the method 500 determines a time-delay 540 and waits for determined time-delay before then proceeding to 535 to transmit traffic flows on multiple links using additional ports. While in this example, it is determined if the traffic type is IPsec traffic, the determination may be more broadly made as to whether the traffic type includes packet sequence number information that may be used later to reorder the packets.

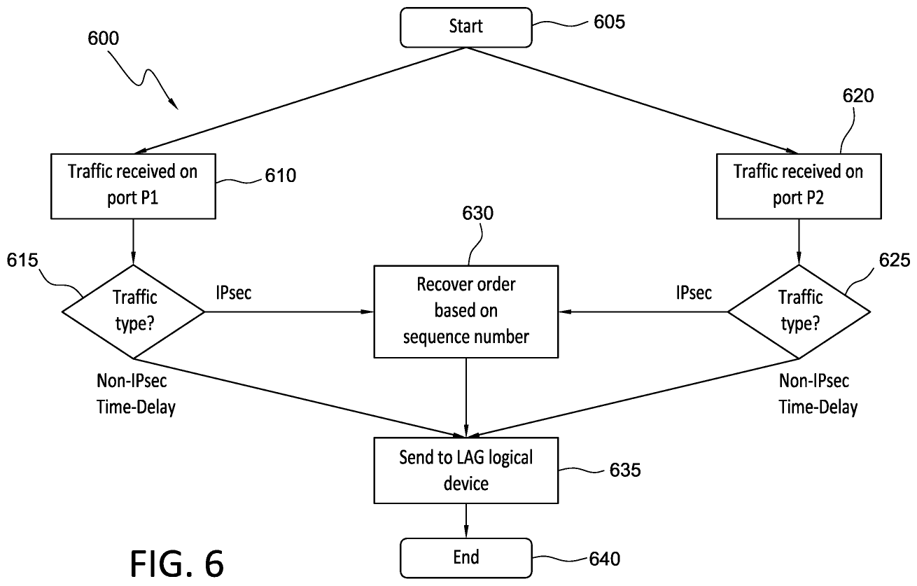

FIG. 6 illustrates a flow diagram of a method incorporating the first and second embodiments for receiving packets from a LAG. The method 600 begins at 605. Traffic is then received at port P1 610 and at port P2 620. The traffic type at each port is determined respectively at 615 and 625. If the traffic received at either port is IPsec traffic, then the method recovers the packet order for traffic flow received on both ports P1 and P2 based upon sequence numbers in the packet headers 630. The restored traffic is then forwarded to a LAG logical device for further processing 635. If the traffic received at either port is not IPsec traffic it is then forwarded to the LAG logical device for further processing 635 as it is assumed that the packets are received in order because of the time delay implemented. The method 600 then ends at 640.

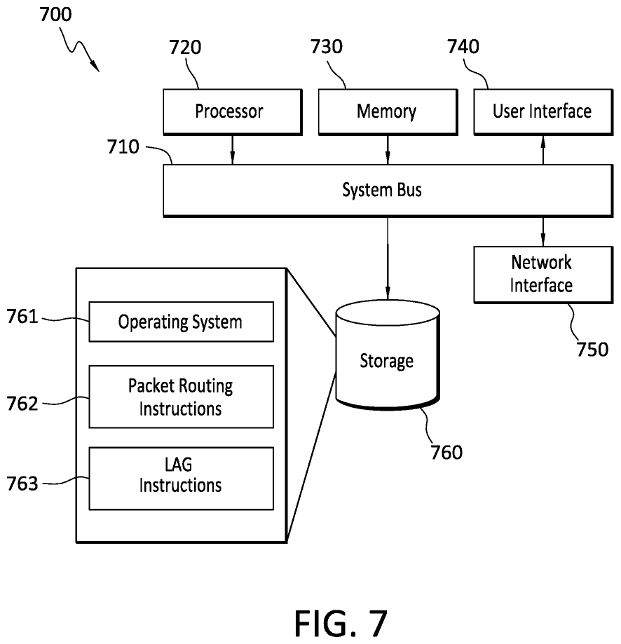

FIG. 7 illustrates an exemplary hardware diagram 700 for implementing the embodiments described above at the SDN controller, BTS, eNodeB, switches, SGW, or PGW. As shown, the device 700 includes a processor 720, memory 730, user interface 740, network interface 750, and storage 760 interconnected via one or more system buses 710. It will be understood that FIG. 7 constitutes, in some respects, an abstraction and that the actual organization of the components of the device 700 may be more complex than illustrated.

The processor 720 may be any hardware device capable of executing instructions stored in memory 730 or storage 760 or otherwise processing data. As such, the processor may include a microprocessor, field programmable gate array (FPGA), application-specific integrated circuit (ASIC), or other similar devices.

The memory 730 may include various memories such as, for example L1, L2, or L3 cache or system memory. As such, the memory 730 may include static random-access memory (SRAM), dynamic RAM (DRAM), flash memory, read only memory (ROM), or other similar memory devices.

The user interface 740 may include one or more devices for enabling communication with a user such as an administrator. For example, the user interface 740 may include a display, a mouse, and a keyboard for receiving user commands. In some embodiments, the user interface 740 may include a command line interface or graphical user interface that may be presented to a remote terminal via the network interface 750. In some embodiments, no user interface may be present.

The network interface 750 may include one or more devices for enabling communication with other hardware devices. For example, the network interface 750 may include a network interface card (NIC) configured to communicate according to the Ethernet protocol. Additionally, the network interface 750 may implement a TCP/IP stack for communication according to the TCP/IP protocols. Various alternative or additional hardware or configurations for the network interface 750 will be apparent.

The storage 760 may include one or more machine-readable storage media such as read-only memory (ROM), random-access memory (RAM), magnetic disk storage media, optical storage media, flash-memory devices, or similar storage media. In various embodiments, the storage 760 may store instructions for execution by the processor 720 or data upon with the processor 720 may operate. For example, the storage 760 may store a base operating system 761 for controlling various basic operations of the hardware 700. Further, software for routing packets 762 may be stored in the memory. Further, software for implementing the LAG 763 may be stored in the memory. This software may implement the various embodiments described above.

It will be apparent that various information described as stored in the storage 760 may be additionally or alternatively stored in the memory 730. In this respect, the memory 730 may also be considered to constitute a “storage device” and the storage 760 may be considered a “memory.” Various other arrangements will be apparent. Further, the memory 730 and storage 760 may both be considered to be “non-transitory machine-readable media.” As used herein, the term “non-transitory” will be understood to exclude transitory signals but to include all forms of storage, including both volatile and non-volatile memories.

While the host device 700 is shown as including one of each described component, the various components may be duplicated in various embodiments. For example, the processor 720 may include multiple microprocessors that are configured to independently execute the methods described herein or are configured to perform steps or subroutines of the methods described herein such that the multiple processors cooperate to achieve the functionality described herein. Further, where the device 700 is implemented in a cloud computing system, the various hardware components may belong to separate physical systems. For example, the processor 720 may include a first processor in a first server and a second processor in a second server.

The embodiments described in FIG. 7 may also be implemented completely in hardware or a combination of both hardware and software.

The embodiments described above provide a technological advantage over current LAG implementations. Current LAG implementations do not provide a way to split single flow over multiple LAG links without causing re-ordering issue, which is needed for efficient and optimized utilization of ports. The embodiments described above provide a mechanism to provide split flows across ports, such that the maximum utilization of available bandwidth across multiple ports may be achieved.

The embodiments described herein have an advantage over multilink point-to-point protocol (MLPPP) and the transmission control protocol (TCP). MLPPP is specially designed for serial interfaces and is not used in 4G or 5G. Even though it uses a sequence number, the embodiments described herein use sequence number within IPsec in combination with the LAG to transmit a single flow across multiple physical links. TCP is an end to end protocol, and by the time TCP figures out that the packets need to be reordered, damage has already been done due to multiple retransmissions of out of order packets which slows down the network further.

Further such embodiments may be implemented on multiprocessor computer systems, distributed computer systems, and cloud computing systems.

Any combination of specific software running on a processor to implement the embodiments of the invention, constitute a specific dedicated machine.

As used herein, the term “non-transitory machine-readable storage medium” will be understood to exclude a transitory propagation signal but to include all forms of volatile and non-volatile memory.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method of transmitting a data flow over a link aggregation group (LAG), comprising:
comparing the bandwidth demand of the data flow with the capacity of a first link assigned to the flow in the LAG;
identifying an underutilized second link in the LAG when the bandwidth demand of the flow is greater than the capacity of the link assigned to the flow resulting in excess packets;
determining if the second link is available;
determining the traffic type of the traffic flow;
calculating a time delay and delaying excess packets of the traffic flow by the calculated time delay when the determined traffic type does not include a packet sequence number; and
sending excess packets of the traffic flow on the second link.

2. The method of claim 1, further comprising sending the excess packets of the traffic flow on the first link when the second link is not available.

3. The method of any of claims 1 and 2, wherein the time delay is calculated based upon a first link speed, a second link speed, a first link packet length, and a second link packet length.

4. The method of claim 3, wherein the time delay is also calculated based upon a randomly generated time delay.

5. The method of any of claims 1 to 4, wherein sending excess packets of the traffic flow on the second link further includes moving a transmit affinity of the flow from the first link to the second link.

6. The method of claim 5, further comprising:
determining that the bandwidth demand of the flow is less than the capacity of a first link after sending excess packets of the traffic flow on the second link; and
moving a transmit affinity of the flow from the second link to the first link.

7. A method of processing data flows over a plurality of links in a link aggregation group (LAG) at
a network node, comprising:
receiving data packets in a first flow from a first link;
receiving data packets in the first flow from a second link;
determining the traffic type of the first flow from the first link;
determining the traffic type of the first flow from the second link;
recovering the order of data packets in the first flow when the determined traffic type of the first flow includes a packet sequence number; and
sending the reordered data packets to a LAG logical device.

8. The method of claim 7, further comprising sending the data packets from the first link and the second link to the LAG logical device when the determined traffic type does not include a packet sequence number.

9. The method of claim 8, further comprising:
comparing the bandwidth demand of a second transmitted flow with the capacity of a third link assigned to the second flow in the LAG;
identifying an underutilized fourth link in the LAG when the bandwidth demand of the second flow is greater than the capacity of the third link assigned to the flow resulting in excess packets;
determining if the fourth link is available;
determining the traffic type of the second traffic flow;
calculating a time delay and delaying excess packets of the second traffic flow by the calculated time delay when the determined traffic type does not include a packet sequence number; and
sending excess packets of the second traffic flow on the fourth link.

10. The method of any of claims 7 to 9, wherein the sequence number is part of an internet protocol security (IPsec) protocol authentication header (AH).

11. The method of any of claims 7 to 9, wherein the packet sequence number is part of an encapsulating security payload (ESP) header.

12. A network node for transmitting a data flow over a link aggregation group (LAG), comprising:
a processor;
a memory including computer code, wherein the memory and the computer code configured to, with the processor, cause the network node to at least perform:
comparing the bandwidth demand of the data flow with the capacity of a first link assigned to the flow in the LAG;
identifying an underutilized second link in the LAG when the bandwidth demand of the flow is greater than the capacity of the link assigned to the flow resulting in excess packets;
determining if the second link is available;
determining the traffic type of the traffic flow;
calculating a time delay and delaying excess packets of the traffic flow by the calculated time delay when the determined traffic type does not include a packet sequence number; and
sending excess packets of the traffic flow on the second link.

13. The network node of claim 12, wherein the memory and the computer code configured to, with the processor, cause the network node to further perform sending the excess packets of the traffic flow on the first link when the second link is not available.

14. The network node of any of claims 12 and 13, wherein the time delay is calculated based upon a first link speed, a second link speed, a first link packet length, and a second link packet length.

15. The network node of claim 14, wherein the time delay is also calculated based upon a randomly generated time delay.

16. The network node of any of claims 12 to 15, wherein sending excess packets of the traffic flow on the second link further includes moving a transmit affinity of the flow from the first link to the second link.

17. The network node of claim 16, wherein the memory and the computer code configured to, with the processor, cause the network node to further perform:
determining that the bandwidth demand of the flow is less than the capacity of a first link after sending excess packets of the traffic flow on the second link; and
moving a transmit affinity of the flow from the second link to the first link.

18. A network node for processing data flows over a plurality of links in a link aggregation group (LAG), comprising:
a processor;
a memory including computer code, wherein the memory and the computer code configured to, with the processor, cause the network node to at least perform:
receiving data packets in a first flow from a first link;
receiving data packets in the first flow from a second link;
determining the traffic type of the first flow from the first link;
determining the traffic type of the first flow from the second link;
recovering the order of data packets in the first flow when the determined traffic type of the first flow includes a packet sequence number; and
sending the reordered data packets to a LAG logical device.

19. The network node of claim 18, wherein the memory and the computer code configured to, with the processor, cause the network node to further perform sending the data packets from the first link and the second link to the LAG logical device when the determined traffic type does not include a packet sequence number.

20. The network node of claim 19, wherein the memory and the computer code configured to, with the processor, cause the network node to further perform:
comparing the bandwidth demand of a second transmitted flow with the capacity of a third link assigned to the second flow in the LAG;
identifying an underutilized fourth link in the LAG when the bandwidth demand of the second flow is greater than the capacity of the third link assigned to the flow resulting in excess packets;
determining if the fourth link is available;
determining the traffic type of the second traffic flow;
calculating a time delay and delaying excess packets of the second traffic flow by the calculated time delay when the determined traffic type does not include a packet sequence number; and
sending excess packets of the second traffic flow on the fourth link.

21. The network node of any of claims 18 to 20, wherein the sequence number is part of an internet protocol security (IPsec) protocol authentication header (AH).

22. The network node of any of claims 18 to 20, wherein the packet sequence number is part of an encapsulating security payload (ESP) header.
